(19) United States
(12) Patent Application Publication
(10) Pub. No.: US 2023/0371134 A1
(43) Pub. Date: Nov. 16, 2023

(54) HEATING ELEMENT FOR EXHAUST LINE

(71) Applicant: FAURECIA SYSTEMES D'ECHAPPEMENT, NANTERRE (FR)

(72) Inventors: Valentin SAGE-AUBRIOT, AUXON-les-VESOUL (FR); Alain MERCIER, NOMMAY (FR)

(21) Appl. No.: 18/143,681

(22) Filed: May 5, 2023

(30) Foreign Application Priority Data
May 11, 2022 (FR) 22 04473

(51) Int. Cl. H05B 3/42

(52) U.S. Cl. CPC H05B 3/42

(57) ABSTRACT

The disclosure relates to a heating element for an exhaust line, comprising a housing, a heating disc, a first electrode, and at least one second electrode. The heating disc comprises a first contact point and a second contact point. The second electrode comprises a contact element connecting a second connector to a second contact point with an angular offset, in order to be able to offset angularly the second connector. The housing comprises a peripheral orifice suitable for accommodating the contact element. The contact element is electrically insulated from the housing and from the heating disc outside the contact point thereof.

### CROSS-REFERENCE TO RELATED APPLICATION

This application is a U.S. non-provisional application claiming the benefit of French Application No. 22 04473, filed on May 11, 2022, which is incorporated herein by reference in its entirety.

### TECHNICAL FIELD

The disclosure relates to a heating element for an exhaust line.

### BACKGROUND

An exhaust line comprises a pipe that is able to convey exhaust gases produced by a heat engine. The pipe comprises an inlet, connected to an exhaust outlet of a heat engine, and an outlet in the open air. A purification component is arranged along the pipe and is able to treat the exhaust gases in order to reduce pollutants before the exhaust gases exit into the open air. It is sometimes necessary, mainly in the phase of starting the heat engine, to heat the exhaust gases, typically to exceed an activation temperature of a purification component.

Also, it is known to produce a heating element, also called an EHC (Electrically Heated Catalyst) comprising a heating disc, arranged across the pipe, in order to be passed through by the exhaust gases. Heating the heating disc, conventionally electrically, by the Joule effect, thus makes it possible to heat the exhaust gases passing through the heating disc.

According to one embodiment, for its electrical power supply, the heating disc comprises two contact points, located on its periphery and diametrically opposite. This is, for example, the case with a heating disc comprising a coil leading from a first contact point, at the periphery of the heating disc, to a second contact point, at the periphery of the heating disc, diametrically opposite the first contact point.

Such a heating disc is conventionally supplied with electricity by way of two electrodes each connected to one of the contact points. This leads to two supply cables arranged at the periphery and diametrically opposite. Such a configuration is complex to integrate. However, it is desirable to be able to place these two power supply cables closer to one another or even adjacent.

Also, it is known to angularly offset at least one of the supply cables via a contact element angularly offsetting the contact of at least one of the electrodes.

### SUMMARY

The disclosure proposes a solution performing such an angular offset according to a particularly advantageous embodiment in that it advantageously combines a maximum compactness and ease of manufacture.

To that end, an object of the disclosure is a heating element for an exhaust line, comprising a housing, a heating disc, a first electrode, and at least one second electrode. The housing is substantially cylindrical along an axis and along a section. The heating disc is arranged across the section of the housing, the section of the heating disc being inscribed within the section of the housing and substantially identical to the section of the housing and comprising a first contact point and a second contact point for supplying the heating disc. The first electrode comprises a first connector to a first supply cable. The at least one second electrode comprises a second connector to a second supply cable and a contact element. The first connector is arranged in line with the first contact point and connected directly to the first contact point. The second connector is offset angularly relative to the second contact point and connected to the second contact point via the contact element, in order to be able to offset angularly the second connector. The housing comprises an orifice suitable for accommodating the contact element, and the contact element is electrically insulated from the housing and from the heating disc outside the second contact point thereof.

Particular features or embodiments, usable alone or in combination, are:
the contact element comprises at least one first connection, arranged at a first end, configured to be connected to the second contact point of the heating disc and a second connection, arranged at most at a second end, configured to be connected to the second connector,
the at least one first connection is arranged on the edge face and/or on at least one of the faces of the heating disk,
the contact element has, in projection onto the housing, a solid shape substantially identical and strictly inscribed within the hollow shape of the orifice, preferentially with a substantially constant clearance on the periphery of the contact element,
the contact element is configured to be located mostly in the space left free by the orifice,
the angular extent of the contact element between the first connection and the second connection is equal to the desired angular offset between the two connectors, and is less than the angular extent of the contact element between the first end and the second end,
the heating element further comprises an electrically insulating pad enveloping the contact element at least on the outer face and periphery thereof,
the heating element further comprises a protective cover covering the contact element and the optional pad,
the cover comprises a piercing facing the second connection, so as to allow the second connector of the second electrode to pass through and further comprises an electrical insulation between the second connector and the cover,
the cover is secured to the housing on the periphery of the cover, preferentially by welding and still preferentially by a continuous and closed cord.

According to a second aspect of the disclosure, an exhaust line comprising such a heating element.

### BRIEF DESCRIPTION OF THE DRAWINGS

The disclosure will be better understood on reading the following description, given solely by way of example, and with reference to the appended figures in which:

FIG. 1 shows, in perspective view, a heating element,

FIG. 2 shows, in an exploded perspective view, the heating element of FIG. 1,

FIG. 3 shows in detail, in perspective view, a contact element,

FIG. 4 shows, in a sectional front view along a plane perpendicular to the axis A, the heating element of FIG. 1, and

FIG. 5 shows, in perspective view, an alternative embodiment of the contact element.

### DETAILED DESCRIPTION

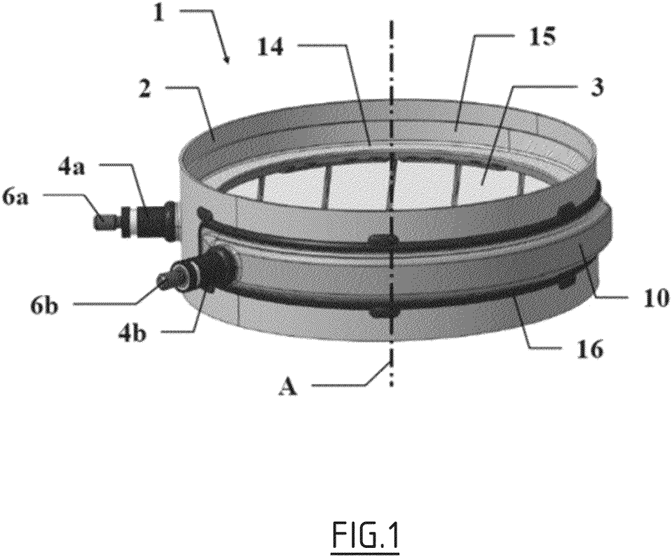

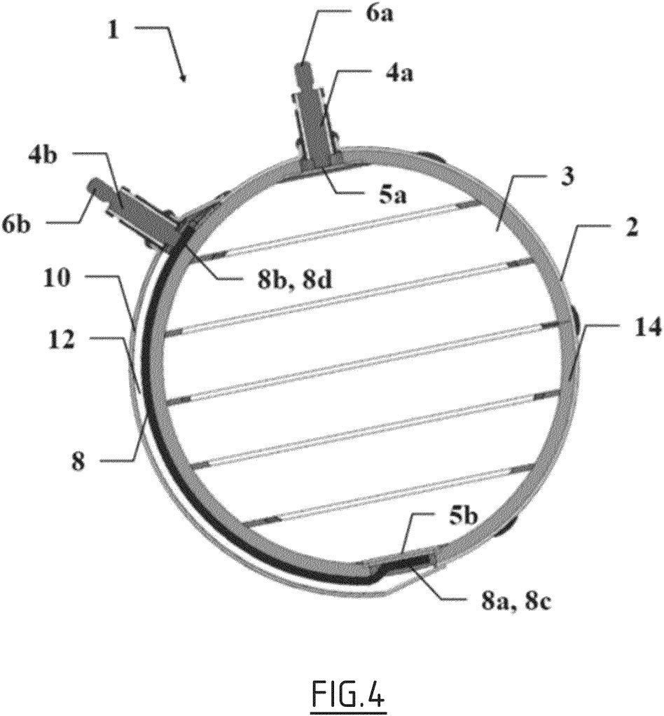

With reference to FIGS. 1, 2 or 4, the disclosure relates to a heating element 1 for an exhaust line. Such a heating element 1 comprises a housing 2, a heating disc 3, a first electrode 4a, and at least one second electrode 4b. The housing 2 is substantially cylindrical. This cylinder extends along an axis A and has a section S that can be of any shape. The shape of the section S substantially takes up the shape of the section of the pipe of the exhaust line wherein the heating element 1 is located. By way of illustration, the section S may have the shape of a square, rounded square, ellipse or even preferentially, as shown in the figures, a circle.

The heating disc 3 is arranged across the section S of the housing 2, or the plane of the heating disc 3 is substantially perpendicular to the axis A. The heating disc 3 is shaped so as to occupy substantially the entire section S of the housing, so that all the exhaust gases pass through the heating disc 3. Also, the section S′ of the heating disc 3 is strictly inscribed within the section S of the housing 2 in order to be able to insert the heating disc 3 into the housing 2. Further, the section S′ of the heating disc 3 is substantially identical to the section S of the housing 2, so that all the exhaust gases pass through the heating disc 3. According to one possible embodiment, the section S′ of the heating disc 3 is deduced from the section S of the housing 2 by a homothety of a ratio substantially equal to 1, by lower value.

The heating disc 3 comprises a first contact point 5a and a second contact point 5b for supplying the heating disc 3. The first and second contact points 5a, 5b are arranged at the periphery of the heating disc 3. Due to constraints related to the flow of the current through the heating disc 3, the first and second contact points 5a, 5b are generally angularly spaced apart. The angle separating the first and second contact points 5a, 5b may be any angle, up to an angle of 180° or the two contact points 5a, 5b are diametrically opposite one another, as shown.

The first electrode 4a comprises a first connector 6a to a first power supply cable (not shown). According to the shown embodiment, this first connector 6a comprises, for example, a threaded end capable of accommodating an eyelet (not shown) integral with the end of the first power supply cable and a nut, screwed onto the threaded end, to hold said eyelet.

The first connector 6a is arranged in line with the first contact point 5a. It is connected directly to the first contact point 5a. This connection can be carried out by any method, such as welding or screwing.

Said at least one second electrode 4b comprises a second connector 6b to a second power supply cable (not shown). According to the shown embodiment, this second connector 6b comprises, for example, a threaded end capable of accommodating an eyelet (not shown) integral with the end of the second power supply cable, and a nut screwed onto the threaded end to hold said eyelet. Said at least one second electrode 4b also comprises a contact element 8.

The second connector 6b is offset angularly relative to the second contact point 5b. The second connector 6b is connected to the second contact point 5b via the contact element 8. The contact element 8 has a shape that follows the periphery of the section S of the housing 2, therefore remaining substantially in a plane perpendicular to the axis A. This advantageously makes it possible to angularly offset the second connector 6b. Thus, even if the contact points 5a, 5b on the heating disc 3 are diametrically opposite, the connectors 6a, 6b, and with them the associated power supply cables, can be angularly close, and where appropriate, adjacent.

The disadvantage of such an approach is that the thickness of such a contact element 8, which is added to the thickness of the housing 2, and even to the thickness of other protective elements, such as a cover and/or an insulating mat, for example, leads to a significant increase in the bulk of the heating element 1.

Also, according to an important feature of the disclosure, the housing 2 is thinned by cutting an orifice 9 in line with the contact element 8. According to this feature, the housing 2 comprises an orifice 9, advantageously peripheral, able to accommodate the contact element 8. This accommodation is done by electrically insulating the contact element 8 from the housing 2. This insulation can be obtained by providing sufficient space around the contact element 8 so that it cannot have any contact between the contact element 8 and the housing 2, generally metal. Indeed, the contact element 8 is at the electrical potential of the second electrode 4b, while the housing 2 is grounded to the vehicle and it is not desired to create a short circuit.

The orifice 9, thus cut out in the wall of the housing 2, is a through orifice in thickness, that is, radially. It is configured so as to be able to reduce the angular extent between the second contact point 5b and the second connector 6b. Also, it has a preferential, or even exclusive, elongation in a sectional plane, namely a plane perpendicular to the axis A.

The first electrode 4a must pass through the wall of the housing 2. This is achieved by a piercing 17 made in the wall of the housing 2 between the first contact point 5a and the first connector 6a, all three radially aligned.

Likewise, the second electrode 4b must pass through the wall of the housing 2. This is achieved by the orifice 9 which allows the contact element 8 to pass through.

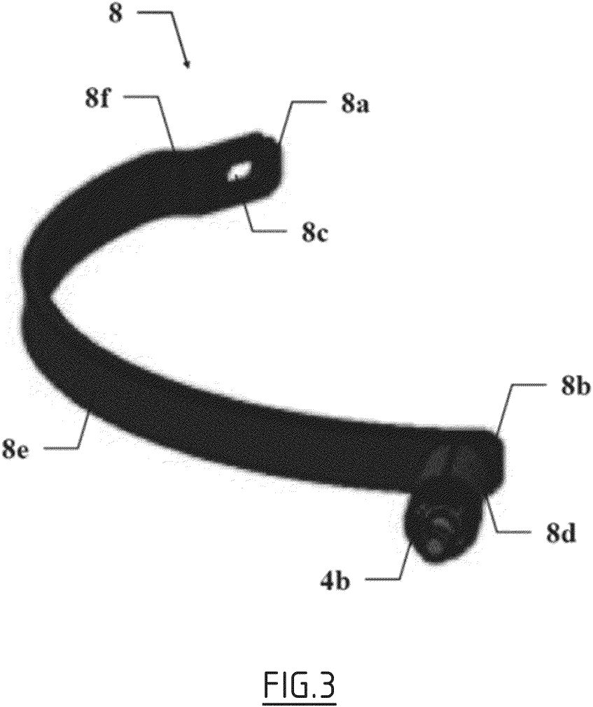

According to another feature, more particularly visible in FIG. 3, the contact element 8 extends mainly, following the shape of the housing 2, and particularly the shape of the orifice 9, between a first end 8a and a second end 8b. The contact element 8 comprises, between these two ends 8a, 8b, a body 8e. The contact element 8 comprises a first connection 8c arranged at the first end 8a. This first connection 8c is configured to be connected to the second contact point 5b of the heating disc 3. For this, the contact element 8 advantageously comprises a double bend 8f in order to facilitate the docking of the second contact point 5b. The connection between the first connection 8c and the second contact point 5b can be achieved by any method, such as welding or screwing. It is advantageously arranged on the edge of the heating disc 3.

The contact element 8 further comprises a second connection 8d. This second connection 8d is arranged at any point of the body 8e and at most at the second end 8b. This second connection 8d is designed to be connected to the second connector 6b. The connection between the second connection 8d and the second connector 6b may be carried out by any method, such as welding or screwing.

According to another feature, the contact element 8 is cut out from a sheet, preferentially metal, the contact element 8 having to be electrically conductive. Advantageously, the thickness of said sheet is less than or equal to the thickness of the housing 2, in line with the orifice 9. Thus, the body 8e of the contact element 8 can advantageously be housed, substantially entirely, in the orifice 9.

According to another feature, not shown, the contact element 8 comprises a branch running along a face of the heating disc 3.

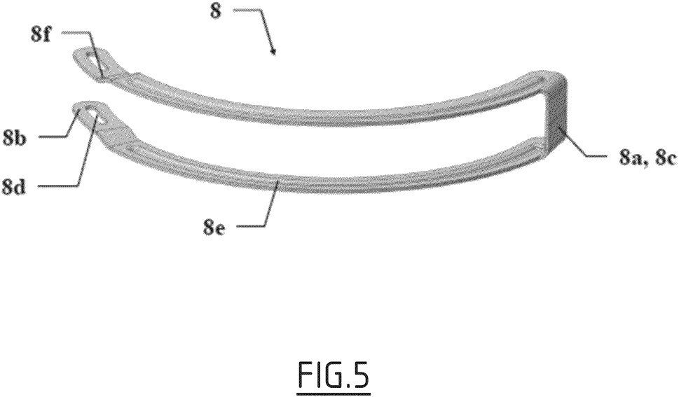

According to another feature, more particularly shown in FIG. 5, the contact element 8 is made by way of two such branches, substantially parallel and advantageously connected to one another by at least one axial bar, so as to form a U, an H or a ladder. As shown, the contact element 8 here comprises two substantially parallel branches along the faces of the heating disc 3. This embodiment is advantageous in that the body 8e, reduced to two strips, the orifice 9 can advantageously be reduced to two slots, arranged on either side of the heating disc 3, always at the periphery or a single wide bore in order to leave the space at the connection 8c with the electrode 4b.

It may be noted that the second branch is advantageous in that, in cooperation with the first branch, it allows the contact element 8 to clamp the edge of the heating disc 3 and thus help hold the heating element 8 in position relative to the heating disc 3. Also, it is the close part of the junction between the two branches, that is to say the part close to the end 8a in FIG. 5, which is useful. Also, one of the branches can be shortened, a single branch extending to the end 8b and ensuring the connection 8d.

In this case, the at least one first connection 8c is arranged facing the edge face of the heating disc 3, while the second connection 8d is arranged facing the faces of the heating disc 3.

According to another feature, not shown, the contact element 8 can pass through, at least locally, the heating disc 3.

According to another feature, the contact element 8 has, in projection onto the housing 2, a solid shape substantially identical to and strictly inscribed within the hollow shape of the orifice 9. Thus, the body 8e of the contact element 8 can be housed substantially entirely in the volume cut by the orifice 9. The “strictly inscribed” feature here contributes to the fact that the contact element 8 does not have any contact, or risk of contact, with the housing 2. In addition, the clearance separating the shape of the contact element 8 and the shape of the orifice 9 is substantially constant over the periphery of the contact element 8. This clearance is determined such that no contact can take place between the contact element 8 and the orifice 9, including taking into account any potential deformations and/or thermal expansions and including a certain safety reserve.

According to another feature, the complete form of the contact element 8 is determined so that the contact element 8, that is to say substantially the entire body 8e, is mostly located in the space left free by cutting of the orifice 9.

According to another feature, the angular extent of the contact element 8 between the first connection 8c and the second connection 8d is equal to the desired angular offset between the two connectors 6a, 6b. By construction, it is less than the angular extent of the contact element 8 between the first end 8a and the second end 8b. Indeed, it should be noted that the connections 8c, 8d are not necessarily arranged at the respective ends 8a, 8b. As shown, the first connection 8c is preferentially arranged at the first end 8a. As shown, the second connection 8d may be arranged at the second end 8b. However, in order to vary the desired angular extent between the two connectors 6a, 6b, it is advantageous, without completely changing the definition of the contact element 8, to place the second connection 8d at any point of the body 8e, not necessarily coincident with the second end 8b.

In order not to interfere with the first electrode 4a, the angular extent of the contact element 8, between the first end 8a and the second end 8b, is strictly less than 180°.

It has been seen that the electrical insulation between the contact element 8 and the housing 2 is mainly obtained by a relative dimensioning of the orifice 9 with a clearance. According to another alternative or complementary feature, the electrical insulation is made by inserting an insulator between the contact element 8 and the housing 2. Thus, an electrically insulating pad 12 can be arranged, enclosing the contact element 8. This pad 12 covers at least the outer face of the contact element 8, namely the face looking radially outwards from the heating element 1. Still advantageously, the pad 12 also covers the periphery of the contact element 8 by being interposed between the contact element 8 and the housing 2 in the surface defined by the wall of the housing 2 and the orifice 9. Such a pad 12 is made of any electrically insulating material, such as textile, woven or non-woven fibers or ceramic fibers.

This material is advantageously deformable in order to be able to be pressed against the contact element 8, for example, by a cover 10.

Alternatively or complementarily, it is possible to improve the electrical insulation by depositing an insulating varnish on the contact element 8, on the housing 2, or on both.

According to another feature, the heating element 1 also comprises a protective cover 10. As shown in FIGS. 1, 2 and 4, this cover 10 entirely covers the contact element 8. If a pad 12 is incorporated, the cover 10 also covers this pad 12 entirely and advantageously compresses it against the contact element 8.

Also, the cover 10 has substantially the same angular extent, by higher value, than the contact element 8.

According to another feature, the cover 10 comprises a piercing 11. This piercing 11 is arranged facing the second connection 8d. It is configured so as to allow the second connector 6b to pass through the second electrode 4b. The cover 10 also comprises an electrical insulation between the second connector 6b and the cover 10 at the level of the piercing 11. Indeed, the second connector 6b is at the electrical potential of the second electrode 4b, while the cover 10, in continuity with the housing 2, is grounded to the vehicle.

According to another feature, the cover 10 is secured to the housing 2. This securing is advantageously carried out on the periphery of the cover 10. This securing is preferentially carried out by welding. Further, this welding is preferentially carried out continuously, for example by a continuous bead 16 all the way around. This continuity advantageously makes it possible to produce a seal to gases as well as liquids.

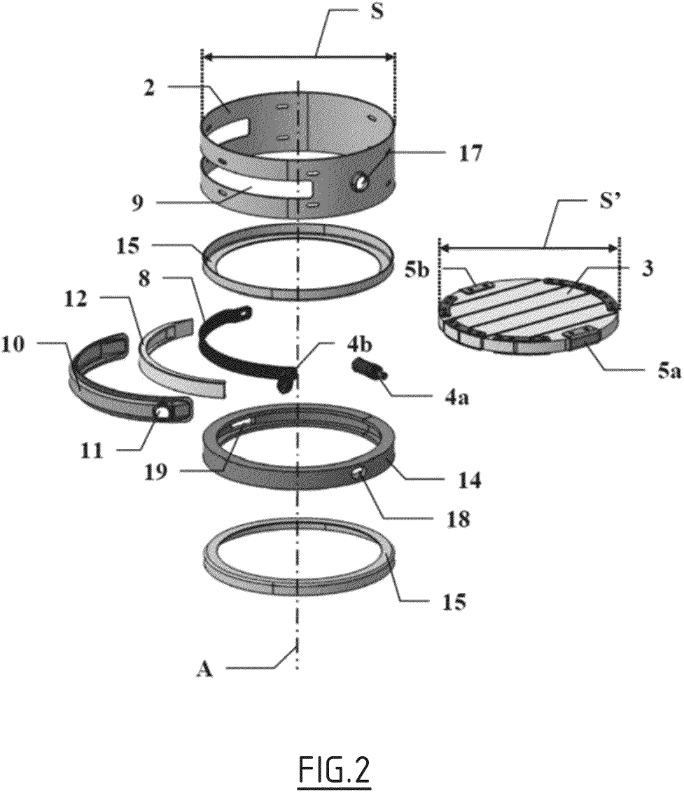

As shown in FIG. 2, a heating element 1 comprises a housing 2. A heating disc 3 is arranged in this housing. The heating disc 3 is electrically insulated from the housing 2 by an insulating collar 14 surrounding the heating disc 3. The heating disc 3 is held in position by way of two rings 15, arranged laterally, on either side of the heating disc 3.

The insulating collar 14 comprises a first piercing 18. This first piercing 18 allows the passage, through the insulating collar 14, of the first connector 6a of the first electrode 4a and the connection of the first connector 6a to the first contact point 5a.

The insulating collar 14 also comprises a second piercing 19. This second piercing 19 allows passage through the insulating collar 14 of the second electrode 4b. More specifically, this second piercing 19, here of rectangular shape, allows the passage of the contact element 8, more particularly at its bend 8f. This allows the connection of the second connector 6b to the second contact point 5b.

The disclosure also relates to an exhaust line comprising a heating element 1 according to any one of the features previously described.

The disclosure has been shown and described in detail in the drawings and the preceding description. This must be considered as illustrative and given by way of example and not as limiting the disclosure to this only description. Many alternative embodiments are possible.

### LIST OF REFERENCE SIGNS

A: axis,
1: heating element,
2: housing,
3: heating disc,
4a, 4b: electrode,
5a, 5b: contact point,
6a, 6b: connector,
8: contact element,
8a, 8b: end,
8c, 8d: connection,
8e: body,
8f: bend,
9: orifice,
10: cover,
11: piercing,
12: insulating pad,
14: insulating collar,
15: ring,
16: weld bead,
17, 18, 19: piercing

1. A heating element for an exhaust line, comprising:
a housing that is substantially cylindrical along an axis and along a housing section;
a heating disc arranged across the housing section, a disc section of the heating disc being inscribed in the housing section and being substantially identical to the housing section and comprising a first contact point and a second contact point for supplying the heating disc;
a first electrode comprising a first connector to a first supply cable; and
at least one second electrode, comprising a second connector to a second supply cable and a contact element, the first connector being arranged in line with the first contact point and connected directly with the first contact point and the second connector being offset angularly relative to the second contact point and connected with the second contact point via the contact element, in order to be able to offset angularly the second connector, and wherein the housing comprises an orifice suitable for accommodating the contact element, the contact element being electrically insulated from the housing and from the heating disc outside the second contact point.

2. The heating element according to claim 1, wherein the contact element comprises at least one first connection, arranged at a first end, configured to be connected to the second contact point of the heating disc and a second connection, arranged at most at a second end, configured to be connected to the second connector.

3. The heating element according to claim 2, wherein the at least one first connection is arranged on an edge face of the heating disc.

4. The heating element according to claim 1, wherein the contact element has, in projection onto the housing, a solid shape substantially identical to and strictly inscribed to a hollow shape of the orifice, preferentially with a clearance that is substantially constant on a periphery of the contact element.

5. The heating element according to claim 1, wherein the contact element is configured to be located mostly in a space left free by the orifice.

6. The heating element according to claim 2, wherein an angular extent of the contact element between the at least one first connection and the second connection is equal to a desired angular offset between the first connector and the second connector, and is less than an angular extent of the contact element between the first end and the second end.

7. The heating element according to claim 1, further comprising an electrically insulating pad enveloping the contact element at least on an outer face and periphery thereof.

8. The heating element according to claim 7, further comprising a protective cover covering the contact element and an optional electrically insulating pad.

9. The heating element according to claim 8, wherein the contact element comprises at least one first connection, arranged at a first end, configured to be connected to the second contact point of the heating disc and a second connection, arranged at most at a second end, configured to be connected to the second connector, and wherein the protective cover comprises a piercing facing the second connection so as to allow the second connector of the at least one second electrode to pass through, and further comprises an electrical insulation between the second connector and the protective cover.

10. The heating element according to claim 8, wherein the protective cover is secured to the housing on a periphery of the protective cover, preferentially by welding and further preferentially by a continuous and closed bead.

11. An exhaust line comprising the heating element according to claim 1.
